(19) United States
(12) Patent Application Publication
(10) Pub. No.: US 2022/0185241 A1
(43) Pub. Date: Jun. 16, 2022

(54) SENSOR CLEANING WITH SELF-HEATED FLUID OR AIR

(71) Applicant: Continental Automotive Systems, Inc., Auburn Hills, MI (US)

(72) Inventor: Paul Vranjes, Santa Barbara, CA (US)

(73) Assignee: Continental Automotive Systems, Inc., Auburn Hills, MI (US)

(21) Appl. No.: 17/247,444

(22) Filed: Dec. 11, 2020

(51) Int. Cl. B60S 1/66

(52) U.S. Cl. CPC B60S 1/66

(57) ABSTRACT

A sensor cleaning system, having a pump, a tank containing a fluid, the tank in fluid communication with the pump, a nozzle, at least one valve in fluid communication with the pump and the nozzle, and a sensor unit which controls the pump. During a first mode of operation, the valve is placed in a first configuration, and the pump transfers fluid from the tank, through the sensor unit, and back to the tank. During a second mode of operation, the valve is placed in a second configuration, and the pump transfers fluid from the tank, through the sensor unit, to the nozzle. During both modes of operation, heat is transferred from the sensor unit to the fluid as the fluid passes through the sensor unit, increasing the temperature of the fluid. The heated fluid sprayed from the nozzle is used to clean a detection component, such as a sensor.

### FIELD OF THE INVENTION

The invention relates generally to a sensor cleaning system, which uses the heat generated by a sensor unit to increase the temperature of a fluid, and the heated fluid is then used to clean a detection component, where the detection component is a component used for detecting objects around a vehicle.

### BACKGROUND OF THE INVENTION

As vehicles have become more advanced, an increased number of features have been implemented to detect objects around a vehicle. Autonomous driving vehicles and vehicles having various driving assist functions incorporate the use of various detection devices, such as sensors, radars, and the like.

These types of detection devices may have various lenses or other surfaces which may accumulate debris during travel of the vehicle. In colder climates, snow and ice may accumulate on the detection device, such that the lens or other surface of the detection device may be covered or blocked, the detection device is therefore prevented from functioning properly, and prevented from detecting objects around the vehicle. The lens or other surface may also be covered with mud, sand, or other debris which may prevent the detection device from functioning properly.

Accordingly, there exists a need to have debris removed from detection devices of a vehicle, such that the detection devices may more consistently function properly.

### SUMMARY OF THE INVENTION

In an embodiment, the present invention is a sensor cleaning system, having a pump, a tank containing a fluid, the tank in fluid communication with the pump, a nozzle, at least one valve in fluid communication with the pump and the nozzle, and a sensor unit which controls the operation of the pump. During a first mode of operation, the valve is placed in a first configuration, and the pump transfers fluid from the tank, through the sensor unit, and back to the tank. During a second mode of operation, the valve is placed in a second configuration, and the pump transfers fluid from the tank, through the sensor unit, and to the nozzle. During both modes of operation, heat is transferred from the sensor unit to the fluid as the fluid passes through the sensor unit, increasing the temperature of the fluid. The heated fluid sprayed from the nozzle during the second mode of operation is able to more effectively clean a detection component, such as a sensor, and is also more effective at removing or melting snow and ice that may have accumulated on the detection component.

In an embodiment, a circulation heat transfer conduit is connected to and in fluid communication with the pump, and a portion of the circulation heat transfer conduit extends through the sensor unit. A coiled portion is part of the circulation heat transfer conduit, such that the coiled portion is located in the sensor unit. During the first mode of operation, the pump is activated and causes the fluid to pass through the coiled portion, and heat is transferred from the sensor unit to the fluid, increasing the temperature of the fluid.

In an embodiment, a conduit connected to and in fluid communication with the valve and the nozzle, and a portion of the conduit extends through the sensor unit, and heat is transferred from the sensor unit to the fluid as the fluid passes through the portion of the conduit which extends through the sensor unit, increasing the temperature of the fluid.

In an embodiment, the sensor cleaning system includes a first valve in fluid communication with the pump and the tank, and a second valve in fluid communication with the tank and the nozzle. During the first mode of operation, the first valve is closed, and the second valve is open, and during the second mode of operation, the first valve is open, and the second valve is closed.

In an embodiment, the operation of the first valve and the second valve is controlled by the sensor unit.

In an embodiment, the sensor cleaning system includes an air compressor, and a third valve in fluid communication with the air compressor, the second valve, and the nozzle. During the first mode of operation, the air compressor releases pressurized air such that the third valve is forced open, and the pressurized air flows through the spray nozzle, and sprays a detection component.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of a first embodiment of a sensor cleaning system, according to embodiments of the present invention;

FIG. 2 is a diagram of a second embodiment of a sensor cleaning system, according to embodiments of the present invention;

FIG. 3 is a diagram of a third embodiment of a sensor cleaning system, according to embodiments of the present invention; and

FIG. 4 is a diagram of a fourth embodiment of a sensor cleaning system, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

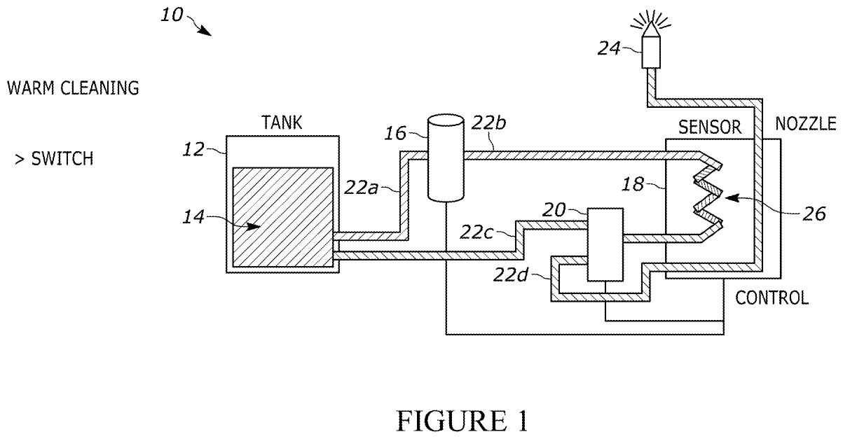

A diagram of a sensor cleaning system with a self-heating feature is shown in FIG. 1 generally at 10. The system 10 includes a tank 12 which contains a cleaning fluid, shown generally at 14. The system 10 also includes a pump 16, a sensor unit 18, and a valve, which in this embodiment is a switch valve 20.

Connected to and in fluid communication with the tank 12 and the pump 16 is a first conduit 22a. Connected to and in fluid communication with the pump 16 and the valve 20 is a second conduit 22b, where a portion of the second conduit 22b extends through the sensor unit 18. Connected to and in fluid communication with the valve 20 and the tank 12 is a third conduit 22c. Also connected to and in fluid communication with the valve 20 is a fourth conduit 22d. A portion of the fourth conduit 22d extends through the sensor unit 18, and is connected to and in fluid communication with a spray nozzle 24.

The sensor unit 18 is also in electrical communication with and controls the activation of the pump 16 and the valve 20, as shown in FIG. 1.

The system 10 has two modes of operation. During a first mode of operation, when the pump 16 is activated, and the valve 20 is in a first configuration, fluid is drawn from the tank 12 by the pump 16 through the first conduit 22a, directed through the second conduit 22b to the valve 20, and the valve 20 in the first configuration directs the fluid through the third conduit 22c back to the tank 12.

During typical operation, the sensor unit 18 generates heat. As the fluid flows through the second conduit 22b, the fluid passes through the portion of the second conduit 22b that extends through the sensor unit 18, exposing the fluid 14 to the heat generated by the sensor unit 18, increasing the temperature of the fluid 14. The fluid 14 that has been heated is then directed through the valve 20, through the third conduit 22c, and back to the tank 12. The pump 16 may remain activated such that the fluid 14 is continuously circulated, resulting in the fluid 14 reaching a desired temperature. Additionally, the heat exchange between the fluid 14 and the sensor unit 18 results in a reduction in temperature of the sensor unit 18, such that in addition to heating the fluid 14, the system 10 of the present invention also provides temperature control of the sensor unit 18.

During a second mode of operation, the pump 16 is activated, and the valve 20 is in a second configuration, fluid is drawn from the tank 12 by the pump 16 through the first conduit 22a, directed through the second conduit 22b to the valve 20, and the valve 20 in the second configuration directs the fluid 14 through the fourth conduit 22d, to the spray nozzle 24. As the fluid 14 passes through the fourth conduit 22d, the fluid 14 is again exposed to heat from the sensor unit 18, providing an additional increase in temperature of the fluid 14. The heated fluid 14 then passes through the spray nozzle 24, where the fluid 14 is used to clean the detection component of the sensor unit 18. The detection component may be any type of component used for detecting objects in the environment around the vehicle. The detection component may include, but is not limited to a lens, a cover, or the like. The heated fluid 14 is able to more effectively clean the detection component and is also more effective at removing or melting snow and ice that may have accumulated on the detection component.

The second conduit 22b in this embodiment is a circulation heat transfer conduit, which also includes a coiled section, shown generally at 26. The shape of coiled section 26 allows for a greater length of the second conduit 22b to be located in the sensor unit 18, such that the fluid 14 is exposed to greater amount of heat generated by the sensor unit 18, and therefore a greater amount of heat transfer takes place. The coiled section 26 is not limited to a specific length or shape, other shapes and lengths could be used to allow for a greater or lesser amount of heat exposure to the fluid 14.

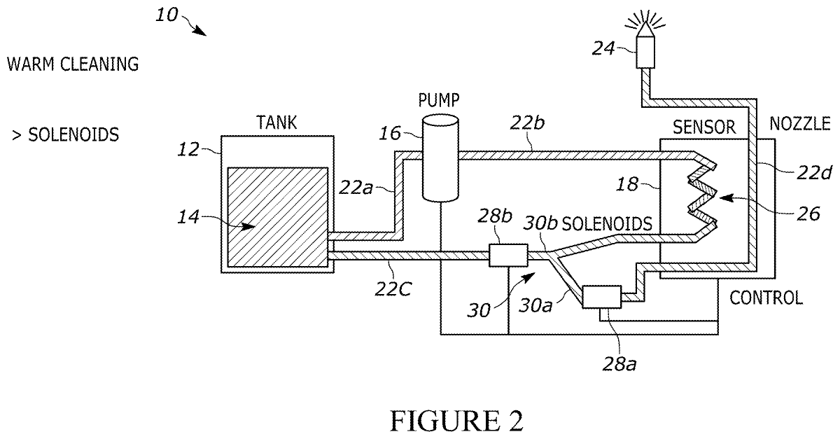

Another embodiment of the system 10 according to the present invention is shown in FIG. 2, with like numbers referring to like elements. In this embodiment, there is no switch valve 20, but rather there are two valves, which in this embodiment are two solenoid valves, a first solenoid valve 28a, and a second solenoid valve 28b.

The second embodiment of the system 10 also has two modes of operation. During a first mode of operation, the solenoid valves 28a,28b are in a first configuration, where the first solenoid valve 28a is in a closed position, and the second solenoid valve 28b is in an open position. During the first mode of operation, when the pump 16 is activated, fluid is drawn from the tank 12 by the pump 16 through the first conduit 22a, directed through the second conduit 22b (the circulation heat transfer conduit) to the valves 28a,28b. In this embodiment, the second conduit 22b has a split portion, shown generally at 30, where the first section 30a of the split portion 30 is connected to and in fluid communication with the first solenoid valve 28a, and the second section 30b of the split portion 30 is connected to and in fluid communication with the second solenoid valve 28b. The fluid 14 flows through the second conduit 22b and into both sections 30a,30b. During the first mode of operation, the fluid 14 flows through the second solenoid valve 28b, which is open, and the fluid 14 is prevented from flowing through the first solenoid valve 28a, which is closed. The fluid 14 is directed through the second solenoid valve 28b, through the third conduit 22c, and back to the tank 12.

During a second mode of operation, the solenoid valves 28a,28b are in a second configuration, where the first solenoid valve 28a is in an open position, and the second solenoid valve 28b is in a closed position. During the second mode of operation, the pump 16 is activated, fluid is drawn from the tank 12 by the pump 16 through the first conduit 22a, directed through the second conduit 22b to the valves 28a,28b. Again, the fluid 14 flows through the second conduit 22b and into both sections 30a,30b. The fluid 14 flows through the first solenoid valve 28a, which is open, and is prevented from flowing through the second solenoid valve 28b, which is closed. The fluid 14 flows through the first solenoid valve 28a, and through the fourth conduit 22d, to the spray nozzle 24. As the fluid 14 passes through the fourth conduit 22d, the fluid 14 is again exposed to heat from the sensor unit 18, providing an additional increase in temperature of the fluid 14. The heated fluid 14 then passes through the spray nozzle 24, where the fluid 14 is used to clean the detection component of the sensor unit 18. As with the previous embodiment, the heated fluid 14 is able to more effectively clean the detection component and is also more effective at removing or melting snow and ice that may have accumulated on the detection component.

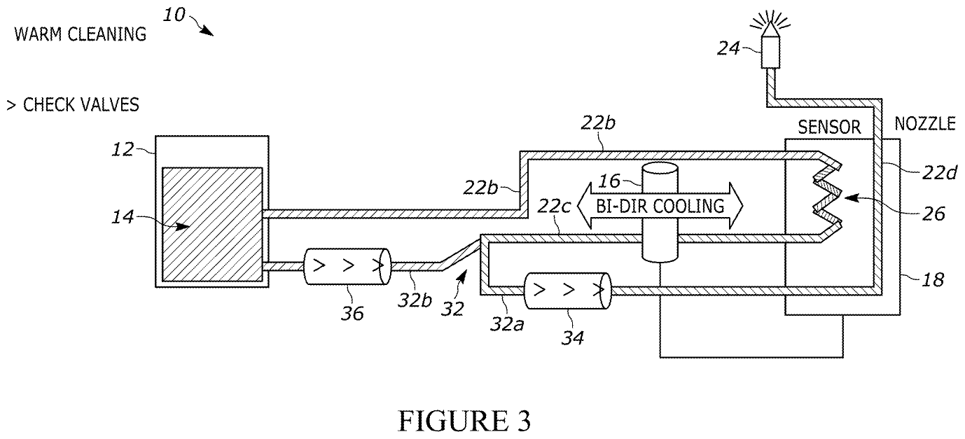

Another embodiment of the present invention is shown in FIG. 3, generally at 10, with like numbers referring to like elements. In this embodiment, the first conduit 22a is eliminated, and the second conduit 22b (the circulation heat transfer conduit) is connected to the tank 12. Also, the third conduit 22c has a split portion, shown generally at 32, where the split portion 32 has a first section 32a and a second section 32b. The first section 32a has a first check valve 34, and the fourth conduit 22d is connected to and in fluid communication with the first check valve 34. The second section 32b has a second check valve 36 and is connected to and in fluid communication with the tank 12. The check valves 34,36 are opened and closed as a result of flow direction and pressure of the fluid 14. In this embodiment, the motor pump 16 is a bi-directional pump 16, such that the bi-directional pump 16 is able to generate flow in two directions.

The system 10 shown in FIG. 3 also has two modes of operation. During the first mode of operation, the bi-directional pump 16 shown in FIG. 3 is rotated in a first direction, and the check valves 34,36 are in a first configuration, where the first check valve 34 is closed, and the second check valve 36 is open. The fluid 14 is drawn from the tank 12, into the second section 32b, where the fluid 14 flows through the second check valve 36. The fluid 14 then flows through the third conduit 22c, through the bi-directional pump 16 and into the second conduit 22b, and then flows from the second conduit 22b into the tank 12.

As the fluid flows through the second conduit 22b, the fluid passes through the portion of the second conduit 22b that extends through the sensor unit 18, exposing the fluid 14 to the heat generated by the sensor unit 18, increasing the temperature of the fluid 14. As with the previous embodiments, the bi-directional pump 16 may remain activated such that the fluid 14 is continuously circulated, resulting in the fluid 14 reaching a desired temperature. Again, the heat exchange between the fluid 14 and the sensor unit 18 results in a reduction in temperature of the sensor unit 18, such that in addition to heating the fluid 14, the system 10 shown in FIG. 3 also provides temperature control of the sensor unit 18. The second conduit 22b in this embodiment also includes the coiled section 26, which allows for a greater length of the second conduit 22b to be located in the sensor unit 18, such that the fluid 14 is exposed to greater amount of heat generated by the sensor unit 18.

During the second mode of operation of the system shown in FIG. 3, the bi-directional pump 16 is rotated in a second direction, and the check valves 34,36 are in a second configuration, where the first check valve 34 is open, and the second check valve 36 is closed. During the second mode of operation, the fluid 14 is drawn from the tank 12, into the second conduit 22b, where the fluid 14 flows through the bi-directional pump 16. The fluid 14 flows through the second conduit 22b, through bi-directional pump 16 and into the third conduit 22c, and into both sections 32a,32b. The fluid 14 flows through the first check valve 34, which is open, and is prevented from flowing through the second check valve 36, which is closed. The fluid 14 flows through the first check valve 34, and through the fourth conduit 22d, to the spray nozzle 24. As with the previous embodiments, the fluid 14 passes through the fourth conduit 22d, the fluid 14 is again exposed to heat from the sensor unit 18, providing an additional increase in temperature of the fluid 14. The heated fluid 14 then passes through the spray nozzle 24, where the fluid 14 is used to clean the detection component of the sensor unit 18. As with the previous embodiments, the heated fluid 14 is able to more effectively clean the detection component and is also more effective at removing or melting snow and ice that may have accumulated on the detection component.

In the embodiment of the system 10 shown in FIG. 3, the bi-directional pump 16 is controlled by the sensor unit 18, the same as in the previous embodiments. In this embodiment, the sensor unit 18 controls which direction the bi-directional pump 16 operates. However, the check valves 34,36 in this embodiment are not controlled by the sensor unit 18. Instead, the check valves 34,36 open and close as a result of the flow direction and pressure of the fluid 14. During the first mode of operation, the activation of the bi-directional pump 16 in the first direction creates a suction pressure in both sections 32a,32b of the split portion 32, drawing the fluid 14 towards the bi-directional pump 16. The suction pressure of the fluid 14 in sections 32a,32b causes the second check valve 36 to open, and the first check valve 34 to close.

Conversely, during the second mode of operation, the activation of the bi-directional pump 16 in the second direction creates a positive pressure in both sections 32a,32b of the split portion 32, moving the fluid 14 away from the bi-directional pump 16, and towards the check valves 34,36. The pressure from the fluid 14 in both sections 32a,32b during the second mode of operation causes the second check valve 36 to close and the first check valve 34 to open.

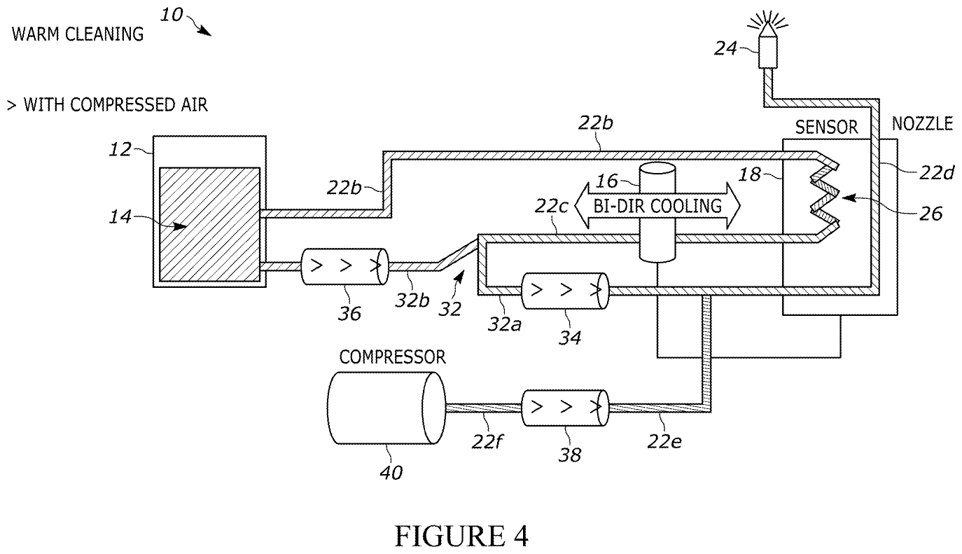

Another embodiment of the present invention is shown in FIG. 4, with like numbers referring to like elements. This embodiment of the system 10 is similar to the embodiment shown in FIG. 3. However, in this embodiment, there is a fifth conduit 22e connected to and in fluid communication with the fourth conduit 22d and a third check valve 38. There is also a sixth conduit 22f connected to and in fluid communication with the check valve 38 and an air compressor 40. The air compressor 40 may be controlled by the sensor unit 18, or the air compressor may be controlled by another independent control unit.

In this embodiment, the air compressor 40 stores pressurized air, and when the bi-directional pump 16 is rotated in the first direction during the first mode of operation, the first check valve 34 is closed. The air compressor 40 releases pressurized air into the sixth conduit 22f, where the pressurized air forces the third check valve 38 to open, and the pressurized air flows through the fifth conduit 22e into the fourth conduit 22d. Because the first check valve 34 is closed, the pressurized air flows through the fourth conduit 22d, to the spray nozzle 24. The pressurized air passes through the fourth conduit 22d, and then passes through the spray nozzle 24, where the pressurized air removes any remaining fluid 14 from the detection component of the sensor unit 18, after the detection component has been cleaned by the fluid 14. Any remaining fluid 14 in the fourth conduit 22d is removed as the pressurized air is forced through the fourth conduit 22d.

During the second mode of operation, the air compressor 40 is inactive, and the third check valve 28 is closed, such that the fluid 14 flows through the fourth conduit 22d during the second mode of operation as previously described.

In all embodiment, during the second mode of operation, the fluid 14 passes through the sensor unit 18 two times, allowing for increased exposure of the fluid 14 to the heat generated by the sensor unit 18.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
a sensor cleaning system, including:
a pump;
a tank containing a fluid, the tank in fluid communication with the pump;
a nozzle;
at least one valve in fluid communication with the pump and the nozzle;
a sensor unit which controls the operation of the pump;
a first mode of operation, and during the first mode of operation, the at least one valve is placed in a first configuration, and the pump transfers fluid from the tank, through the sensor unit, and back to the tank; and
a second mode of operation, and during the second mode of operation, the at least one valve is placed in a second configuration, and the pump transfers fluid from the tank, through the sensor unit, and to the nozzle;
wherein heat is transferred from the sensor unit to the fluid as the fluid passes through the sensor unit, increasing the temperature of the fluid.

2. The apparatus of claim 1, further comprising:
a circulation heat transfer conduit connected to and in fluid communication with the pump, a portion of the circulation heat transfer conduit extending through the sensor unit; and
a coiled portion being part of the circulation heat transfer conduit, the coiled portion located in the sensor unit;
wherein during the first mode of operation, the pump is activated and causes the fluid to pass through the coiled portion, and heat is transferred from the sensor unit to the fluid, increasing the temperature of the fluid.

3. The apparatus of claim 1, further comprising:
a conduit connected to and in fluid communication with the at least one valve and the nozzle;
wherein a portion of the conduit extends through the sensor unit, and heat is transferred from the sensor unit to the fluid as the fluid passes through the portion of the conduit which extends through the sensor unit, increasing the temperature of the fluid.

4. The apparatus of claim 1, wherein the operation of the at least one valve is controlled by the sensor unit.

5. The apparatus of claim 1, the at least one valve further comprising:
a first valve in fluid communication with the pump and the tank; and
a second valve in fluid communication with the pump and the nozzle;
wherein during the first mode of operation, the first valve is closed, and the second valve is open, and during the second mode of operation, the first valve is open, and the second valve is closed.

6. The apparatus of claim 5, wherein the operation of the first valve and the second valve is controlled by the sensor unit.

7. The apparatus of claim 5, further comprising
an air compressor; and
a third valve in fluid communication with the air compressor, the second valve, and the nozzle;
wherein during the first mode of operation, the air compressor releases pressurized air such that the third valve is forced open, and the pressurized air flows through the spray nozzle, and sprays a detection component.

8. A sensor cleaning system, comprising:
a pump;
a sensor unit in electrical communication with and controlling the operation of the pump;
a tank;
at least one valve;
a plurality of conduits, one of the plurality of conduits connected to and in fluid communication with the at least one valve and the pump, and another of the plurality of conduits connected to and in fluid communication with the pump and the tank;
a nozzle in fluid communication with the at least one valve;
a first mode of operation, and during the first mode of operation, the at least one valve is placed in a first configuration, and the pump transfers fluid from the tank, through the sensor unit, and back to the tank; and
a second mode of operation, and during the second mode of operation, the at least one valve is placed in a second configuration, and the pump transfers fluid from the tank, through the sensor unit, and to the nozzle, and the nozzle sprays a detection component with the fluid;
wherein heat is transferred from the sensor unit to the fluid as the fluid passes through the sensor, increasing the temperature of the fluid.

9. The sensor cleaning system of claim 8, further comprising:
a coiled portion being part of a circulation heat transfer conduit and is located in the sensor unit;
wherein during the first mode of operation, fluid passes through the coiled portion, and heat is transferred from the sensor unit to the fluid, increasing the temperature of the fluid.

10. The sensor cleaning system of claim 9, wherein the one of the plurality of conduits connected to and in fluid communication with the at least one valve and the pump further comprising the circulation heat transfer conduit.

11. The sensor cleaning system of claim 9, wherein the another of the plurality of conduits connected to and in fluid communication with the pump and the tank further comprising the circulation heat transfer conduit.

12. The sensor cleaning system of claim 8, the plurality of conduits further comprising a heat transfer conduit extending through the sensor unit and connected to and in fluid communication with the nozzle and the at least one valve.

13. The sensor cleaning system of claim 8, further comprising:
a split portion being part of the one of the plurality of conduits connected to and in fluid communication with the at least one valve and the pump;
a first section being part of the split portion;
a second section being part of the split portion;
the at least one valve further comprising:
a first valve connected to and in fluid communication with the first section, the first valve also in fluid communication with the nozzle; and
a second valve connected to and in fluid communication with the second section, the second valve also in fluid communication with the tank;
wherein during the first mode of operation, the first valve is closed, and the second valve is open, and during the second mode of operation, the first valve is open, and the second valve is closed.

14. The sensor cleaning system of claim 13, wherein the first valve and the second valve are in electrical communication with and are controlled by the sensor unit.

15. The sensor cleaning system of claim 13, wherein the first valve and the second valve are opened and closed as a result of the flow of the fluid during the first mode of operation and the second mode of operation.

16. The sensor cleaning system of claim 13, further comprising:
an air compressor; and
a third valve in fluid communication with the air compressor, the second valve, and the nozzle;
wherein during the first mode of operation, the air compressor releases pressurized air such that the third valve is forced open, and the pressurized air flows through the spray nozzle, and sprays the detection component.
